(19) United States
(12) Patent Application Publication
(10) Pub. No.: US 2008/0285169 A1
(43) Pub. Date: Nov. 20, 2008

(54) MAGNETIC DISK DRIVE

(75) Inventor: Hiroyuki Iwahara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/019,306

(22) Filed: Jan. 24, 2008

Related U.S. Application Data
(63) Continuation of application No. PCT/JP2005/013978, filed on Jul. 29, 2005.

(51) Int. Cl. G11B 21/02

(52) U.S. Cl. 360/76

(57) ABSTRACT

In a magnetic disk drive having a magnetic circuit for moving a magnetic head by driving an actuator having the magnetic head mounted thereon, to a target track, and a base having a height criterion member for carrying out positioning in a height direction of the magnetic circuit as a result of the magnetic circuit being fixed thereto, wherein in a condition in which the magnetic circuit is fixed to the height criterion member, a space is provided between the base and a bottom surface, a spring member is provided for applying force to the magnetic circuit in such a direction that the magnetic circuit is apart from the bottom surface.

### CROSS-REFERENCE TO RELATED APPLICATION

This application is a U.S. continuation application filed under 35 USC 111(a) claiming benefit under 35 USC 120 and 365(c) of PCT application JP2005/013978, filed Jul. 29, 2005. The foregoing application is hereby incorporated herein by reference.

### BACKGROUND OF THE INVENTION

1. Field of the Invention

The present invention relates to a magnetic disk drive, and, in particular, to a magnetic disk drive for carrying out recording/reproduction on a magnetic disk by driving an actuator having a magnetic head provided thereto, with the use of a magnetic circuit mounted to a base.

2. Description of the Related Art

FIGS. 1-3 illustrate a magnetic disk drive 100 which is one example of the related art. FIG. 1 shows an exploded perspective view of the magnetic disk drive 100, FIG. 2 shows a perspective view of the magnetic disk drive 100 in a condition in which it is assembled (a top cover mounted on the top is omitted), and FIG. 3 shows a sectional view taken along a line X1-X1 of FIG. 2.

As shown in each figure, an actuator 122 supports head sliders 114 having magnetic heads mounted thereto is supported by a supporting shaft 140 in such a manner that it can swing, and a voice coil 151 is mounted at a rear end part with respect to the supporting shaft 140. The voice coil 151 is driven by a magnetic circuit 150, and thus, the actuator 122 swings on the supporting shaft 140.

The magnetic circuit 150 is configured by an upper yoke 153A, a lower yoke 153B, an upper magnet 155A, a lower magnet 155B, and so forth. As shown in FIGS. 2 and 3, the upper magnet 155A is disposed on a lower surface of the upper yoke 153A, and the lower magnet 155B is disposed in front of the lower yoke 153B.

A space is formed between the upper magnet 155A and the lower magnet 155B, and the voice coil 151 of the actuator 122 is movably mounted in the space. The voice coil 151, upper yoke 153A, lower yoke 153B, upper magnet 155A, lower magnet 155B and so forth configure a voice coil motor 123 (VCM). The voice coil motor 123 acts as a driving source for swinging the actuator 122 on the supporting shaft 140.

It is noted that, hereinafter, among the elements of the voice coil motor 123, the upper and lower yokes 153A, 153B, and the upper and lower magnets 155A, 155B, particularly excluding the voice coil 151, will be referred to as the magnetic circuit 150.

When the magnetic circuit 150 is fixed to a base 113, as shown in FIG. 1, screws 126 are used after the actuator 122 and a FPC holding plate 116 are mounted to the magnetic circuit 150. The base 113 has screwing parts 125 and criterion screwing parts 127 having screw holes formed therein into which the screws 126 are driven. Further, the magnetic circuit 150 and the FPC holding plate 116 have brim parts 156 having insertion holes formed therein for inserting the screws 126. In this configuration, the magnetic circuit 150 and the FPC holding plate 116 are fixed to the base 113 when the screws 126 are inserted through the insertion holes formed in the brim parts 156, and are driven into the screwing parts 125 and the criterion screwing parts 127.

It is noted that, in a condition in which the FPC holding plate 116 is fixed to the base 113, a bottom plate opening part 113C formed in the base 113 is covered by the FPC holding plate 116 in an airtight manner. The bottom plate opening part 113C is an opining for drawing out wires from the magnetic heads and the voice coil motor 123.

In the magnetic disk drive 100, it is necessary to position the head sliders 114 (magnetic heads) to predetermined positions on magnetic disks 101 with high accuracy, for the purpose of carrying out magnetic recording/reproduction processing properly. For this purpose, the actuator 122 and the supporting shaft 140 supporting it are disposed to the base 113 with high accuracy.

At this time, in a view point of keeping a condition of the head sliders 114 (magnetic heads) and the magnetic disks 101 upon recording/reproduction satisfactorily, positioning thereof in a height direction with respect to the base 113 is important. Further, since the magnetic circuit 150 has the voice coil 151 of the actuator 122 inserted thereto as mentioned above, it is necessary to improve accuracy in the height direction in positioning the magnetic circuit 150 with respect to the base 113.

For this purpose, as shown in FIG. 1, the plurality of (for example, three) criterion screwing parts 127 used as a height criterion are formed. Then, the screws 126 are used to fix the magnetic circuit 150 after the magnetic circuit 150 is placed on the criterion screwing parts 127. Thereby, positioning in the height direction of the magnetic circuit 150 with respect to the base 113 is achieved. The criterion screwing parts 127 are formed with high accuracy, and as a result, to obtain height accuracy of the mantic circuit 150 can be achieved only as from the magnetic circuit 150 being placed and the screws 127 being driven.

By thus satisfactorily obtaining height accuracy of the actuator 122 and the magnetic circuit 150 with respect to the base 113 as mentioned above, it is possible to keep a condition of the head sliders 114 (magnetic heads) and the magnetic disks 101 upon recording/reproduction satisfactorily.

Further, in order to keep height accuracy of the magnetic circuit 150 with respect to the base 113 satisfactorily, it is necessary to cause a bottom surface of the magnetic circuit 150 to be apart from a bottom plate 113A of the base 113 (a dimension of thus being apart, i.e., a space, is referred to as ΔH, in FIG. 3). This is because, if the bottom surface of the magnetic circuit 150 came into contact with the bottom plate 113A of the base 113, the brim parts 156 might float from the criterion screwing parts 127, and thus, it might not be possible to obtain height accuracy with the use of the criterion screwing parts 127.

However, fixing force may not be so large in the above-mentioned configuration that the magnetic circuit 150 acting as the driving source is fixed onto the three criterion screwing parts 127, that the magnetic circuit 150 may vibrate due to swinging reaction force of the actuator 122 which may violently swing upon seeking. In one hand, for the purpose of reducing a thickness of the magnetic disk drive 100, the above-mentioned space between the magnetic circuit 150 and the bottom plate 113A is set to have the minimum height.

As a result, when the magnetic circuit 150 vibrates as mentioned above, the vibration may be transmitted to the base 113, which may then vibrate accordingly, whereby noise may be generated. As a method to prevent such noise from being generated, as disclosed by Japanese Laid-Open Patent Application No. 8-167259, a method is proposed in which a damper member is inserted in the space between the magnetic circuit 150 and the bottom plate 113A of the base 113.

### SUMMARY OF THE INVENTION

As the damper member is inserted in the space between the magnetic circuit 150 and the bottom plate 113A of the base 113 as mentioned above, transmission of vibration of the magnetic circuit 150 to the base 113 can be controlled.

However, in such a configuration that the damper member is inserted between the magnetic circuit 150 and the bottom plate 113A, the damper member is compressed and thus deformed when the damper member is thus inserted. Thereby, resilient restoration force may be applied to the bottom plate 113A. As a result, the bottom plate 113A may be deformed. If deformation of the bottom plate 113A thus occurs, the height accuracy of the magnetic circuit 150 and the actuator 122 may degrade.

A general object of the present invention is to provide an improved and useful magnetic disk drive, which solves the above-mentioned problem in the related art.

A more specific object of the present invention is to provide a magnetic disk drive in which, while height accuracy of a magnetic circuit with respect to a base is maintained, vibration can be controlled.

In order to achieve the object, according to the present invention, in a magnetic disk drive having a magnetic circuit for moving a magnetic head to a target track of a magnetic disk by driving an actuator having the magnetic head mounted thereon, and a base having a height criterion member provided thereto for carrying out positioning in a height direction of the magnetic circuit as a result of the magnetic circuit being fixed thereto, wherein in a condition in which the magnetic circuit is fixed to the height criterion member, a space is provided between the magnetic circuit and a bottom surface of the base, a spring member is provided to the base for applying such a force to the magnetic circuit that the magnetic circuit is apart from the bottom surface of the base.

In this configuration of the present invention, the spring member provided to the base applies force to (or presses) the magnetic circuit in such a direction that the magnetic circuit is apart from the bottom plate of the base. As a result, vibration of the magnetic circuit can be prevented from being generated.

Further, in the above-mentioned configuration of the present invention, the magnetic circuit may be supported by a plurality of the height criterion members, and the spring member may come into contact with the magnetic circuit at a position which is approximately the center among the plurality of height criterion members.

In this configuration of the present invention, since the spring member comes into contact with the magnetic circuit at a position which is approximately the center among the plurality of height criterion members, the magnetic circuit can have force applied thereto (or can be pressed) stably without being biased.

Further, in order to achieve the above-mentioned object, according to the present invention, in a magnetic disk drive having a magnetic circuit for moving a magnetic head to a target track of a magnetic disk by driving an actuator having the magnetic head mounted thereon, and a base having a height criterion member provided thereto for carrying out positioning in a height direction of the magnetic circuit as a result of the magnetic circuit being fixed thereto, wherein in a condition in which the magnetic circuit is fixed to the height criterion member, a space is provided between the magnetic circuit and a bottom surface of the base, a spring member of a cantilever spring configuration is provided to the base, and the spring member applies force to the magnetic circuit in such a direction that the magnetic circuit is apart from the bottom surface of the base.

In this configuration of the present invention, since the spring member has the cantilever spring configuration, it is possible to make a position at which the spring member applies force to the magnetic circuit apart from a position at which the spring member is connected with the base.

Further, in the above-mentioned configuration of the present invention, one end of the spring member may be connected with the base at a position at which the base has high rigidity, and the other end of the spring member may come into contact with the magnetic circuit at a position to the inside from the position at which the one end of the spring is connected with the base.

In this configuration of the present invention, the end of the spring member having the cantilever configuration on the side on which the spring member comes into contact with the magnetic circuit and the end thereof on the opposite side are connected with the base at positions at which rigidity of the base is high. As a result, even when vibration may be generated in the magnetic circuit, and thus, the spring member may be deformed, the base can be prevented from being deformed due to the deformation of the spring member.

Further, in the above-mentioned configuration of the present invention, one end of the spring member may be connected with the base near a peripheral position of the base, and the other end of the spring member may come into contact with the magnetic circuit at a position to the inside from the position at which the one end of the spring is connected with the base.

In this configuration of the present invention, as the peripheral position of the base has high rigidity since a side wall is provided there, it is possible to effectively prevent the base from being deformed, as a result of the end of the spring member having the cantilever configuration on the side opposite to the side on which the spring member comes intro contact with the magnetic circuit being connected with the base at that position.

Further, in the above-mentioned configuration of the present invention, the spring member may be integrally formed to the base.

In this configuration of the present invention, since the spring member is integrally formed to the base, it is possible to reduce the number of required parts/components of the magnetic disk drive.

Further, in the above-mentioned configuration of the present invention, the spring member may be a spring washer.

In this configuration of the present invention, as the spring member is a spring washer, since the spring washer is such that selection of a spring constant can be easily made, it is possible that the spring member applies force to (or presses) the magnetic circuit with force which is suitable for controlling vibration of the magnetic circuit.

In the present invention, since the spring member provided to the base applies force to (or presses) the magnetic circuit in such a direction that the magnetic circuit is apart from the bottom surface of the base, it is possible to prevent vibration from being generated in the magnetic circuit.

### BRIEF DESCRIPTION OF THE DRAWINGS

Other objects and further features of the present invention will become more apparent from the following detailed description when read in conjunction with the accompanying drawings:

FIG. 1 shows an exploded perspective view of one example of a magnetic disk drive in the related art;

FIG. 2 shows a perspective view of the magnetic disk drive shown in FIG. 1;

FIG. 3 shows a sectional view of the magnetic disk drive shown in FIG. 1, taken along a line X1-X1 of FIG. 2;

FIG. 4 shows an exploded perspective view of a magnetic disk drive in one embodiment of the present invention;

FIG. 5 shows a perspective view of the magnetic disk drive shown in FIG. 4, in which part thereof is cut off;

FIG. 6 shows a sectional view of the magnetic disk drive shown in FIG. 4, in particular, showing part in the neighborhood of a cantilever spring part;

FIG. 7 shows a noise level of a magnetic disk drive in the related art;

FIG. 8 shows a noise level of the magnetic disk drive in one embodiment of the present invention;

FIG. 9A shows a front view of a spring washer which may be used instead of the cantilever spring part; and

FIG. 9B shows a side view of the spring washer shown in FIG. 9A.

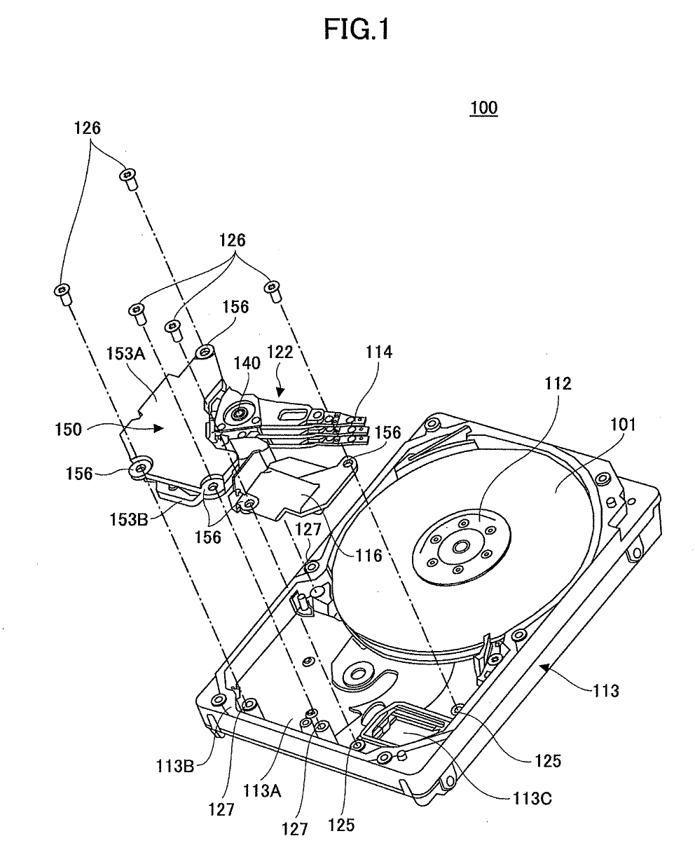

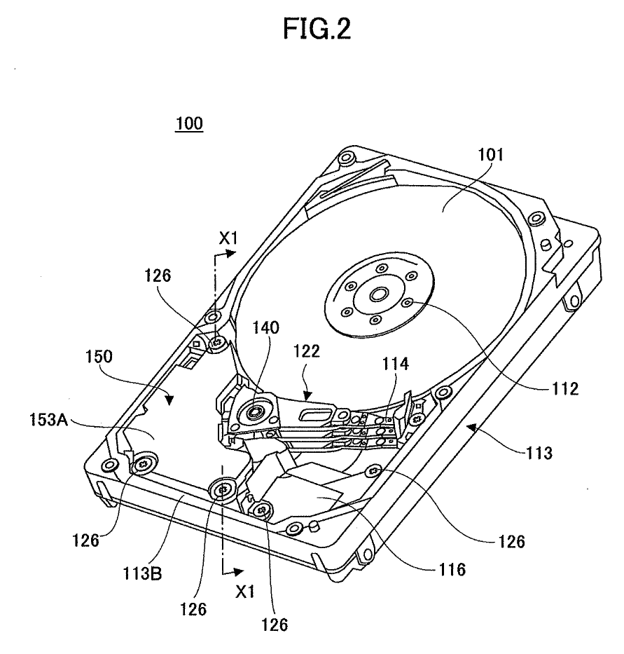

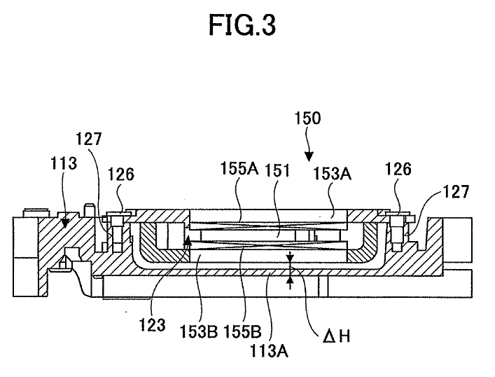

DESCRIPTION OF REFERENCE NUMERALS

| | |
|---|---|
| 10 | Magnetic disk drive |
| 11 | Magnetic disk |
| 13 | Base |
| 14 | Magnetic circuit |
| 22 | Actuator |
| 23 | Voice coil motor |
| 24 | Height adjustment protrusion |
| 25 | Screwing part |
| 27 | Screw |
| 51 | Voice coil |
| 53A | Upper yoke |
| 53B | Lower yoke |
| 60 | Cantilever spring part |
| 60A | Force applying part |
| 60B | Connecting part |
| 70 | Spring washer |

### DETAILED DESCRIPTION OF THE PREFERRED EMBODIMENTS

A best mode of the present invention will now be described with reference to figures.

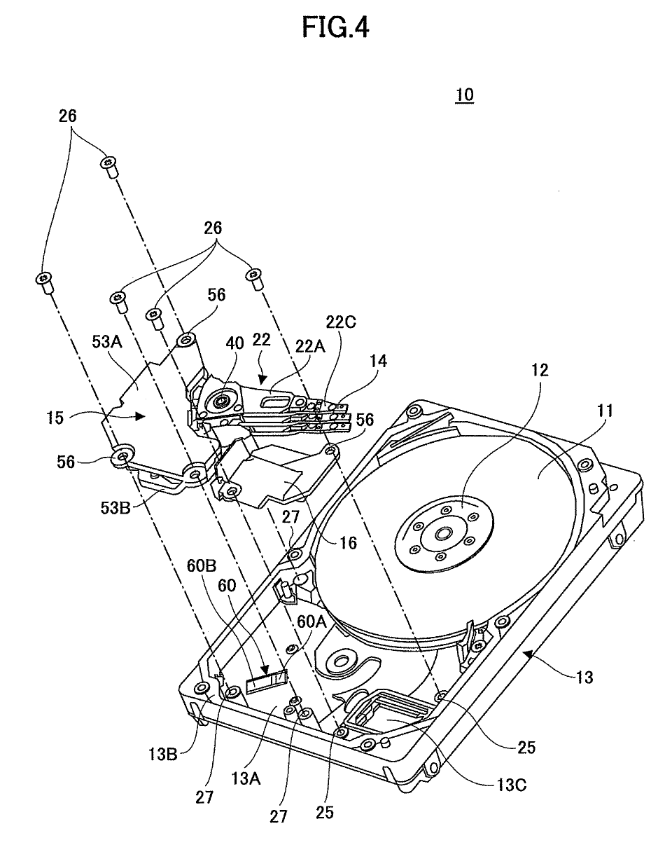

FIGS. 4-6 illustrate a magnetic disk drive 10 in one embodiment of the present invention. In the magnetic disk drive 10 shown in each figure, magnetic disks 11 which act as data recording media, a spindle motor 12 for driving and rotating the magnetic disks 11, an actuator 22 on which head sliders 14 on which magnetic heads are mounted are mounted, a voice coil motor (VCM) 23 for driving and swinging the actuator 22, and so forth, are held in an enclosure configured by a cover (not shown) and a base 13.

The magnetic disks 11 are fixed to a rotor part of the spindle motor 12. The magnetic disks 11 are driven and rotated by the spindle motor 12 upon operation (i.e., upon recording/reproduction) of the magnetic disk drive 10, and are stopped when the magnetic disk drive 10 is not upon operation.

The actuator 22 is supported in such a manner that it can pivot freely on a supporting shaft 40 which stands on the base 13. The actuator 22 has supporting arms 22A and coil arms 22B. The supporting arms 22A have the head sliders 14 mounted thereto with the use of supporting springs 22C at extending end parts thereof.

The head sliders 14 are disposed in such a manner as to face the magnetic disks 11. The head sliders 14 are provided with the magnetic heads (not shown) for recording data, from a control part, to tracks provided on surfaces of the magnetic disks 11, or reading data recorded in tracks of the magnetic disks to send the data to the control part. The head sliders 14 float on the surfaces of the magnetic disks 11 when the magnetic disk drive 10 is upon operation.

A voice coil 51 is disposed on a coil arm 22B of the actuator 22. The voice coil 51 cooperates with a magnetic circuit 15 to configure a voice coil motor 23. The magnetic circuit 15 drives the actuator 22, and thereby, the actuator 22 swings on the supporting shaft 40.

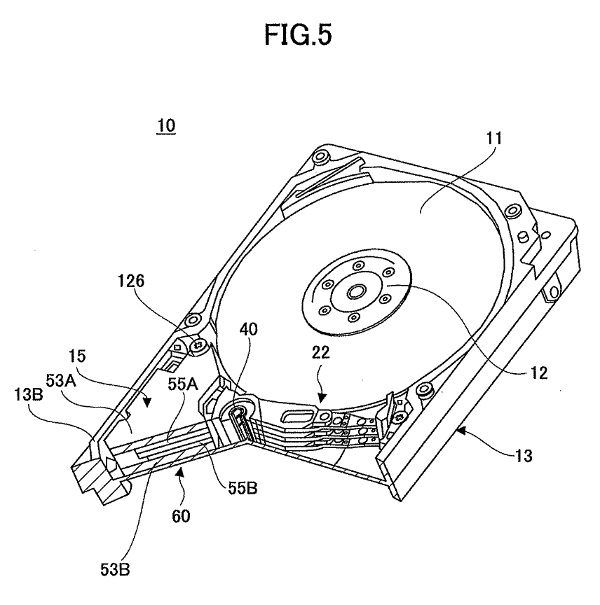

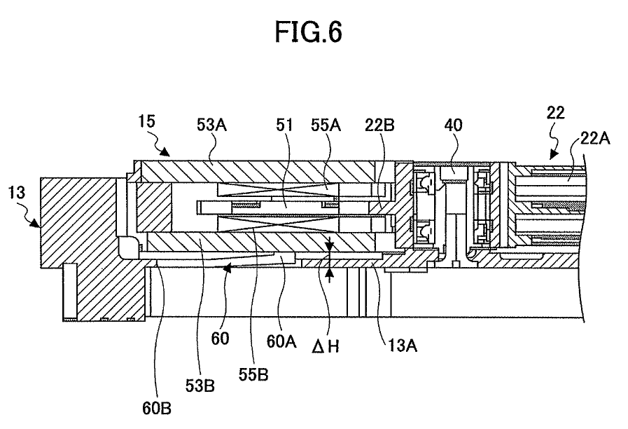

The magnetic circuit 15 is configured by an upper yoke 53A, a lower yoke 53B, an upper magnet 55A, a lower magnet 55B and so forth. As shown in FIG. 6, the lower magnet 55A is disposed on a bottom surface of the upper yoke 53A, and the lower magnet 55B is disposed in front of the lower magnet 53B.

A space is formed between the upper magnet 55A and the lower magnet 55B, and, in the space, the voice coil 51 of the actuator 22 is movably mounted. The voice coil 51, the upper yoke 53A, the lower yoke 53B, the upper magnet 55A, the lower magnet 55B and so forth configure the voice coil motor 23 (VCM). It is noted that, in description of the embodiment of the present invention, hereinafter, among the elements of the voice coil motor 23, the upper and lower yokes 53A, 53B, and the upper and lower magnets 55A, 55B, particularly excluding the voice coil 51, will be referred to as the magnetic circuit 15.

When the magnetic circuit 15 is fixed to the base 13, as shown in FIG. 4, screws 26 are used after the actuator 22 and a FPC holding plate 16 are mounted to the magnetic circuit 15. The base 13 has screwing parts 25 and criterion screwing parts 27 formed thereto having screw holes into which the screws 26 are driven. Further, the magnetic circuit 15 and the FPC holding plate 16 are provided with brim parts 56 having insertion holes for inserting the screw 26. As a result, the magnetic circuit 15 and the FPC holding plate 16 are fixed to the base 13 when the screws 26 are inserted through the insertion holes formed in the brim parts 56, and are driven into the screwing parts 25 and the criterion screwing parts 27.

It is noted that, in a condition in which the FPC holding plate 16 is fixed to the base 13, a bottom plate opening part 13C formed in the base 13 is covered by the FPC holding plate 16 in an airtight manner. The bottom plate opening part 13C is an opining for drawing out wires from the magnetic heads and the voice coil motor 23.

In the magnetic disk drive 10, it is necessary to position the head sliders 14 (magnetic heads) to predetermined positions on magnetic disks 11 with high accuracy, for the purpose of carrying out magnetic recording/reproduction processing properly. In this view point, the actuator 22 and the supporting shaft 40 supporting it are disposed to the base 13 with high accuracy.

At this time, in a view point of keeping a condition of the head sliders 14 (magnetic heads) and the magnetic disks 11 upon recording/reproduction satisfactorily, positioning thereof in a height direction with respect to the base 13 is important as mentioned above. Further, since the magnetic circuit 15 has the voice coil 51 of the actuator 22 inserted thereto as mentioned above, it is necessary to improve accuracy in the height direction in positioning the magnetic circuit 15 with respect to the base 13.

For this purpose, as shown in FIG. 4, the plurality of (for example, three) criterion screwing parts 27 used as a height criterion are formed. Then, the screws 26 are used to fix the magnetic circuit 15 after the magnetic circuit 15 is placed on the criterion screwing parts 27. Thus, positioning of the magnetic circuit 15 in the height direction with respect to the base 13 is carried out. The criterion screwing parts 27 are formed with high accuracy, and thus, height accuracy of the mantic circuit 15 can be obtained only as a result of the magnetic circuit 15 being placed and the screws 27 being driven as mentioned above.

Further, in order to keep height accuracy of the magnetic circuit 15 with respect to the base 13 satisfactorily, it is necessary to provide a space ΔH between the magnetic circuit 15 and the bottom plate 13A (shown in FIG. 6). Further, as mentioned above, as a result of the space ΔH being thus provided, the magnetic circuit 15 may vibrate due to swinging reaction force of the actuator 22 which may violently swing upon seeking, and the vibration may be transmitted to the base 13, which then vibrates accordingly, resulting in noise being generated.

Further, if a damper member were inserted between the magnetic circuit 15 and the bottom plate 13A for the purpose of avoiding generation of noise, the bottom plate 13A might be deformed, and thereby, height accuracy of the magnetic circuit 15 and/or the actuator 22 might degrade as mentioned above.

In the magnetic disk drive 10 in the embodiment of the present invention, instead of the damper member used in the related art, a spring member for applying force to the magnetic circuit 15 in such a direction that the magnetic circuit 15 is apart from the bottom plate 13A of the base 13 (i.e., upward in the figures) is provided. In the embodiment of the present invention, a cantilever spring part 60 is used as the spring member.

The cantilever spring part 60 is formed to the base 13 integrally. By thus forming the cantilever spring part 60 to the base 13 integrally, it is possible to reduce the number of required parts/components of the magnetic disk drive 10.

One end part of the cantilever spring part 60 acts as a force applying part 60A for applying elastic force to the magnetic circuit 15 (specifically, to the lower yoke 53B) upward. The other end part of the cantilever spring part 60 acts as a connecting part 60B for integrally connecting with the bottom plate 13A of the base 13. The cantilever spring part 60 is located in the space formed between the magnetic circuit 15 and the bottom plate 13A (see FIG. 6).

The cantilever spring part 60 configured as described above applies elastic force (or elastically presses) the magnetic circuit 15 upward so that the magnetic circuit 15 is apart from the bottom plate 13A. Thereby, when the actuator 22 swings, the magnetic circuit 15 can be prevented from vibrating, since the magnetic circuit 15 is thus pressed by the cantilever spring part 60. As a result, it is possible to achieve the magnetic disk drive 10 in which generation of noise is thus made little.

The positions at which the force applying part 60A and the connecting part 60B of the cantilever spring part 60 are disposed will now be described particularly. First, the position at which the force applying part 60A comes into contact with the magnetic circuit 15 is determined as being approximately the center among three positions at which the magnetic circuit 15 is supported by the respective three criterion screwing parts 27. As a result of the position at which the force applying part 60A comes into contact with the magnetic circuit 15 is thus determined as being approximately the center among the positions at which the magnetic circuit 15 is supported by the criterion screwing parts 27, force is applied to the magnetic circuit 15 (or the magnetic circuit 15 is pressed) stably without being biased. Therefore, although the single cantilever spring part 60 is used, the magnetic circuit 15 can be positively pressed therewith.

In the embodiment of the present invention, the cantilever spring part 60 is used as the spring member as mentioned above. Thereby, the force applying part 60A and the connecting part 60B of the cantilever spring part 60 can be disposed in such a manner that the force applying part 60A and the connecting part 60B are apart from one another. As a result, it is possible that, while the force applying part 60A is provided approximately at the center among the positions at which the criterion screwing parts 27 support the magnetic circuit 15, the connecting part 60B is located in the proximity of a peripheral position of the bottom plate 13A of the base 13.

Specifically, the connecting part 60B is located in the proximity of a side wall part 13B which is formed to stand in the periphery of the bottom plate 13A. The periphery of the bottom plate 13A at which the side wall part 13B stands is such a portion of the bottom plate 13A that the bottom plate 13A has higher rigidity than that of an inner portion thereof.

As a result of the connecting part 60B being thus located in such a portion of the bottom plate 13A as that having high rigidity, a displacement of the connecting part 60B, which may occur as the magnetic circuit 15 vibrates and force of the vibration is applied to the cantilever spring part 60, can be reduced. Thereby, it is possible to avoid deformation of the base 13 which may otherwise occur due to vibration of the magnetic circuit 15, and thus, it is possible to keep height accuracy of the magnetic circuit 15 and the actuator 22 with high accuracy. In the magnetic disk drive 10 in the embodiment of the present invention, it is possible to avoid generation of noise in the magnetic disk drive 10, while it is possible to keep height accuracy of the magnetic circuit 15 and the actuator 22 with high accuracy.

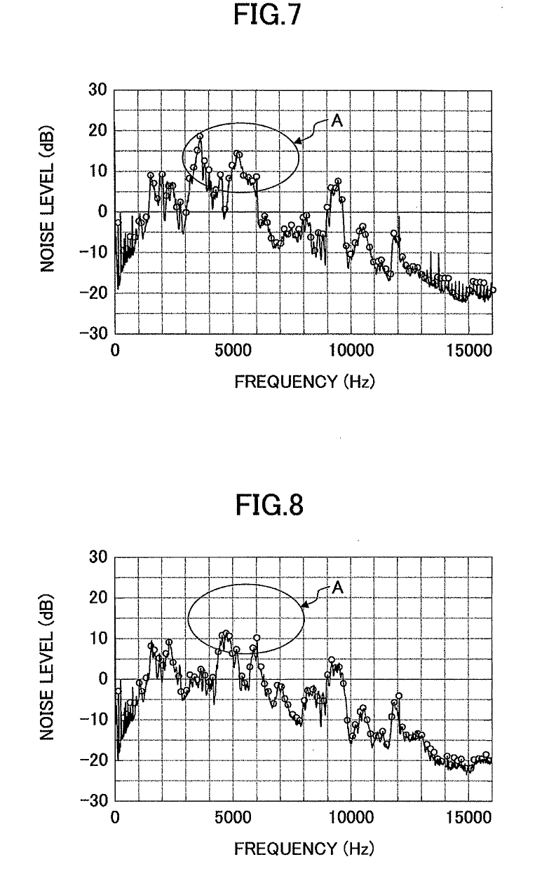

FIGS. 7 and 8 are figures for comparing a noise level of the magnetic disk drive 10 in the embodiment of the present invention with a noise level of a magnetic disk drive in the related art. FIG. 7 shows a noise level of the magnetic disk drive in the related art. As shown, in the magnetic disk drive in the related art, it can be seen that a high noise level exists as indicated by an arrow A in FIG. 7.

In contract thereto, in the magnetic disk drive 10 in the embodiment of the present invention shown in FIG. 8, it can be seen that the above-mentioned high noise level zone A occurring in the related art does not occur. Therefore, from FIGS. 7 and 8, it is possible to prove that noise characteristics are improved in the magnetic disk drive 10 in the embodiment of the present invention in comparison to the magnetic disk drive in the related art.

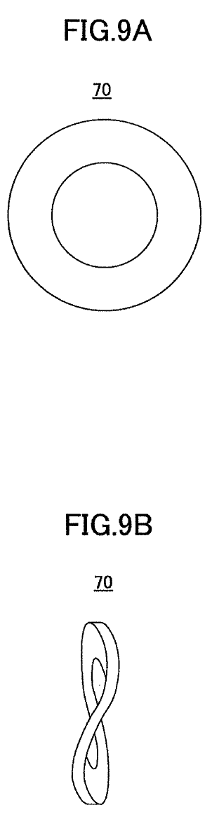

In the embodiment of the present invention described above, the cantilever spring part 60 is used as the spring member for applying force to the magnetic circuit 15 with respect to the bottom plate 13A. However, the spring member is not limited thereto. For example, a spring washer 70 shown in FIGS. 9A and 9B may be used instead. When the spring washer 70 is used as the spring member, it is possible that the spring member applies force to (or presses) the magnetic circuit 15, with force which is suitable to control vibration of the magnetic circuit 15, since selection of a spring constant is easy for the spring washer 70.

While the invention herein disclosed has been described by means of specific embodiments and applications thereof, numerous modifications and variations could be made thereto by those skilled in the art without departing from the scope of the invention set forth in the claims.

What is claimed is:

1. A magnetic disk drive having a magnetic circuit for moving a magnetic head to a target track of a magnetic disk by driving an actuator having the magnetic head mounted thereon, and a base having a height criterion member for carrying out positioning in a height direction of the magnetic circuit as a result of the magnetic circuit being fixed thereto, wherein in a condition in which said magnetic circuit is fixed to the height criterion member, a space is provided between the magnetic circuit and a bottom surface of the base, wherein:
a spring member is provided for applying force to the magnetic circuit in such a direction that the magnetic circuit is apart from the bottom surface of the base.

2. The magnetic disk drive as claimed in claim 1, wherein:
the magnetic circuit is supported by a plurality of the height criterion members, and the spring member comes into contact with the magnetic circuit at a position which is approximately the center among the plurality of height criterion members.

3. A magnetic disk drive having a magnetic circuit for moving a magnetic head to a target track of a magnetic disk by driving an actuator having the magnetic head mounted thereon, and a base having a height criterion member for carrying out positioning in a height direction of the magnetic circuit as a result of the magnetic circuit being fixed thereto, wherein in a condition in which said magnetic circuit is fixed to the height criterion member, a space is provided between the magnetic circuit and a bottom surface of the base, wherein:
a spring member of a cantilever spring configuration is provided to the base, and the spring member applies force to the magnetic circuit in such a direction that the magnetic circuit is apart from the bottom surface.

4. The magnetic disk drive as claimed in claim 3, wherein:
one end of the spring member is connected with the base at a position at which the base has high rigidity, and the other end of the spring member comes into contact with the magnetic circuit at a position inside from the position at which the one end of the spring is connected with the base.

5. The magnetic disk drive as claimed in claim 3, wherein:
one end of the spring member is connected with the base near a peripheral position of the base, and the other end of the spring member comes into contact with the magnetic circuit at a position inside from the position at which the one end of the spring is connected with the base.

6. The magnetic disk drive as claimed in claim 3, wherein:
the spring member is integrally formed to the base.

7. The magnetic disk drive as claimed in claim 1, wherein:
the spring member comprises a spring washer.
